(19) United States
(12) Patent Application Publication
(10) Pub. No.: US 2007/0205006 A1
(43) Pub. Date: Sep. 6, 2007

(54) Fire-Extinguishing Method, Apparatus and Means

(76) Inventor: Goran Sundholm, Tuusula (FI)

Correspondence Address: LADAS & PARRY, 26 WEST 61ST STREET, NEW YORK, NY, 10023, US

(21) Appl. No.: 10/592,653

(22) PCT Filed: Apr. 1, 2005
(86) PCT No.: PCT/FI05/00171

§ 371 Date: Sep. 13, 2006

(30) Foreign Application Priority Data
Apr. 2, 2004 (FI) 20040484

(51) Int. Cl. A62C 37/14

(52) U.S. Cl. 169/58; 169/46

(57) ABSTRACT

A fire-extinguishing means which is formed of a pipe or hose element which comprises a wall and a space (W) defined by it for conveying an extinguishing medium. The wall is formed of at least two layers (2, 3), at least one of which is of material sensitive to increased temperature which melts, burns or otherwise weakens as a result of increased temperature so the extinguishing medium being pressurised in the space (W) is able to pass through the wall to its outer side.

### BACKGROUND OF THE INVENTION

A subject of the invention is a fire-extinguishing method as defined in the preamble of claim 1, in which method at least one hose means is arranged to a protected target which means is connected to an extinguishing-medium source.

A subject of the invention is also a fire-extinguishing apparatus as defined in the preamble of claim 13, which apparatus comprises an extinguishing-medium source and a means for conveying the extinguishing medium to at least one nozzle.

A further subject of the invention is a fire-extinguishing means as defined in the preamble of claim 20, which means is comprised of an elongated hose element which comprises a wall and a space defined by it for conveying the extinguishing medium.

Extinguishing fires, especially small fires in spaces or targets which have difficult access or which are, because of their dimensions, difficult to protect with conventional sprinkler equipment, has proved problematic. The most problematic cases are those in which the extinguishing-medium spray cannot be directly aimed at a seat of fire. Such targets are typically, for example, elongated or otherwise confined spaces, such as cable tunnels in which a fire area may typically be located on one of several cable racks. Other targets which are difficult to protect are, for example, ceiling spaces or low attic spaces in buildings.

The object of this invention is to achieve a totally novel solution with which the disadvantages of known prior art are avoided. An object of the invention is to achieve a solution with which the extinguishing medium is guided to the actual fire area also in targets of difficult access. An object of the invention is also to achieve a fixed extinguishing system with which the extinguishing medium is guided directly to the fire area.

The invention is based on an idea that at least part of the piping system arranged in the protected target for conveying extinguishing medium is designed such that, from the effect of the fire, an opening is formed to its wall from which opening the extinguishing medium has access to the actual fire area or its vicinity.

Mainly characteristic for the method according to the invention is that, from the effect of the fire, at least one opening is formed to the wall of a pipe or hose means, which wall is comprised of at least two layers, from which opening the extinguishing medium is brought to the fire area or its vicinity with the pipe or hose means.

In addition, the method according to the invention is characterised by what is stated in claims 2-12.

Characteristic for the apparatus according to the invention is that the apparatus comprises at least one pipe or hose means which is connected to an extinguishing-medium source, the wall of which hose means is at least partially formed of material which burns and/or softens and melts from the effect of intense heat so that at least one opening is formed to that wall of the pipe or hose means for, at least when the pipe or hose means is located in the vicinity of the fire area, spraying the extinguishing medium.

In addition, the apparatus according to the invention is characterised by what is stated in claims 13-19.

It is characteristic for a fire-extinguishing means according to the invention that the wall is formed of at least two layers, at least one of which is of material sensitive to increased temperature, which material melts, burns or otherwise weakens as a result of increased temperature so the extinguishing medium being pressurised in the space is able to pass through the wall to its outer side.

In addition, the means according to the invention is characterised by what is stated in claims 21-29.

A solution according to the invention has numerous significant advantages. The fire-extinguishing means according to the invention enables an extremely favourable manner of bringing and spraying the extinguishing medium to the actual fire area. By utilising a melting and/or burning layer on the surface of the pipe or hose element, extremely sensitive and rapid forming of a spraying opening is achieved. By utilising a reinforcement layer below the surface layer, the pressurised medium achieves the bulging of the reinforcement layer on the formed opening which bulging enlarges the opening created to the hose-element surface and, for its part, also quickens its creation in a fire situation. By utilising a reinforcement layer resistant of high temperatures, such as a metal, especially a steel reinforcement layer, an extinguishing-medium-spray-diverging structure on the opening having formed to the wall is achieved. According to an advantageous embodiment, a pipe or hose means according to the invention is utilised as part of a sprinkler system, whereupon the flow path of extinguishing medium directed at a spraying head is at least partially formed of a pipe or hose means according to the invention. Then, it is possible to protect targets conventionally difficult to extinguish or targets which have been difficult to protect cost-effectively by directing a fire-extinguishing means according to the invention through those spaces, even though the spraying heads intended for the fire extinguishing itself are located in another space. Such spaces to be protected with a solution according to the invention may be, for example, ceiling spaces, attic spaces, cable tunnels and other spaces for electrical devices. By utilising a flexible pipe or hose element, the installation work of the apparatus may be performed easily and cost-effectively.

### BRIEF DESCRIPTION OF THE FIGURES

In the following, the invention will be described in detail by means of an example with reference to the accompanying drawing, wherein

FIG. 1 presents a fire-extinguishing means according to the invention as a cross-section along line I-I in FIG. 2,

FIG. 2 presents part of a fire-extinguishing means according to the invention partially sliced,

FIG. 2A presents a detail from FIG. 2,

FIG. 2B presents a detail from an alternative embodiment,

FIG. 3 presents a cross-section of an apparatus according to the invention,

FIG. 4 presents schematically an apparatus according to the invention,

FIG. 5 presents a second embodiment of the invention,

FIG. 6 presents schematically an embodiment of an apparatus according to the invention, and

FIG. 7 presents schematically part of an embodiment according to

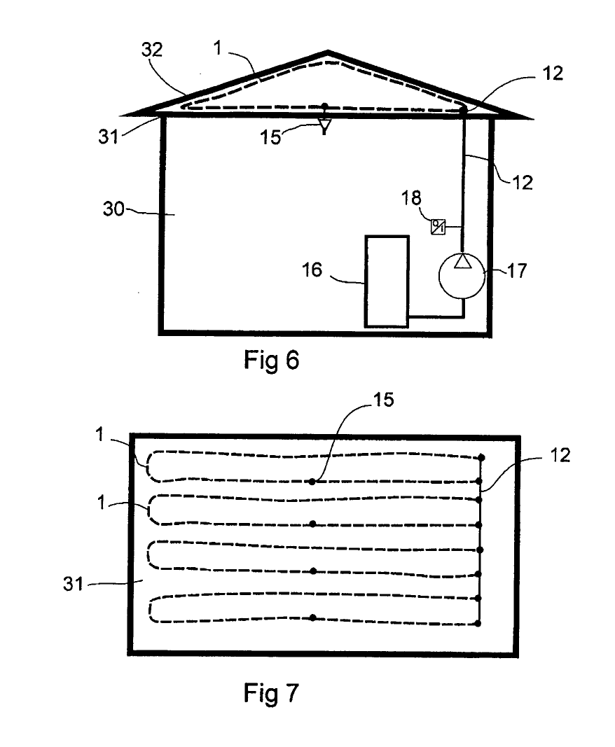

FIG. 6 of an apparatus according to the invention.

### DETAILED DESCRIPTION OF THE INVENTION

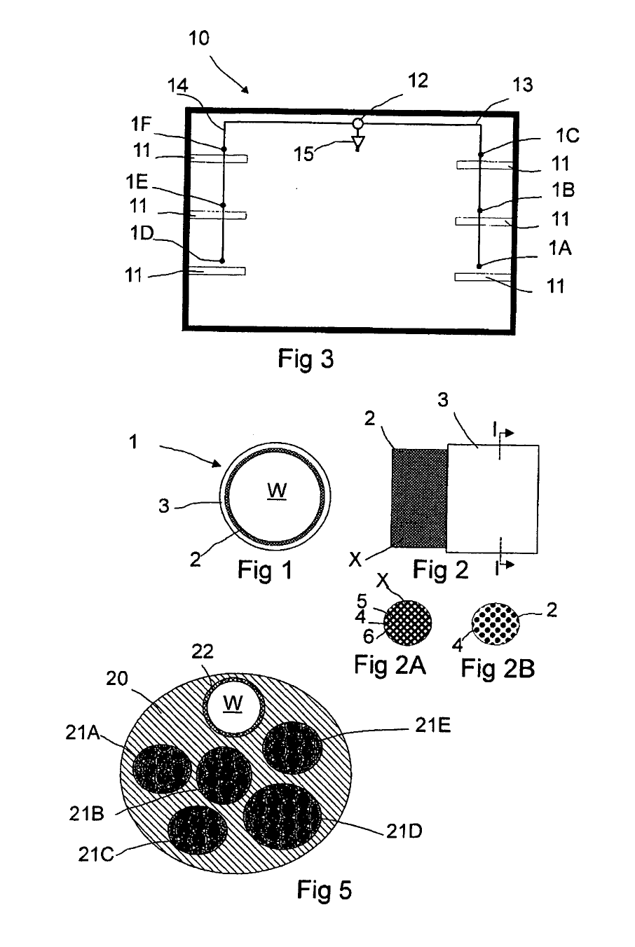

FIGS. 1 and 2 present a simplified view of a fire-extinguishing means utilised in a fire-extinguishing system according to the invention. The fire-extinguishing means is formed of an elongated pipe or hose element which comprises a wall and a space W defined by it for conveying the extinguishing medium. The wall is formed of at least two layers 2, 3, at least one of which is of material sensitive to increased temperature which melts, burns or otherwise weakens as a result of increased temperature so the extinguishing medium being pressurised in the space W is able to pass through the wall to its outer side.

At least one of the wall layers 2, 3 of the pipe or hose element is of fire-resistant material which comprises openings 4. Typically, at least one of the wall layers 2, 3 is of cloth, advantageously of wire-cloth, such as steel-cloth.

At least one of the layers 2, 3 comprises openings 4, thinnings or equivalent. Typically, the reinforcement layer readily has openings. In the embodiment of FIG. 2A, the reinforcement layer is of braiding in which openings 4 are left between threads 4, 5. In the embodiment of FIG. 2B, the reinforcement layer is a covering comprising openings 4. Naturally, the reinforcement layer may also be designed in some other manner. In the event of fire, the surface layer or other heat-sensitive part of the hose means burns or melts from the effect of fire in the vicinity of the fire area, whereupon the extinguishing medium is able to spray through openings 4 to the fire area or its vicinity. The size of the openings is advantageously formed so that the extinguishing medium sprays from one or more openings as a fine spray, when the extinguishing medium is conveyed with pressure to the hose means.

In the embodiment according to the figures, the first layer of the wall from the outside 3 is of thermo-sensitive material, and at least one following layer 2 is of reinforcement material which better endures fire.

When examining the wall from outside to inside, after the reinforcement layer 2 there is more thermo-sensitive material. By means of this, the inner surface of the hose element is achieved to be smooth, whereupon the flow resistance becomes low.

The extinguishing medium utilised in the fire-extinguishing means is typically liquid, gas, or a mixture of liquid and gas.

According to an advantageous embodiment of the invention, a high-pressure-enduring hydraulic hose known per se is advantageously utilised as the pipe or hose means. Surprisingly, this has discovered to have suitable characteristics which are required of an extinguishing means according to the invention.

In the embodiment of FIG. 5, a fire-extinguishing means 22 has been integrated to a pipe, hose and/or cable means 20. Such may comprise several cables or pipelines 21A, 21B, 21C, 21D, 21E. Then, one avoids the separate installation of an extinguishing line. This has a great significance especially in cases in which one aims at protecting long cables which may be the length of, for example, several dozens of kilometres. The pipe, hose or cable means may comprise different electrical or telecommunications cables, pipelines for transferring a medium or equivalent for the protection of which in fire events the fire-extinguishing means is connected. The embodiment of FIG. 5 is only one manner to connect the extinguishing-medium line 22 as part of the pipe, hose or cable means. The extinguishing-medium line 22 has an equivalent reinforcement layer as presented in the embodiments of FIGS. 1 and 2.

The invention also relates to a fire-extinguishing method, in which method at least one pipe or hose means 1 is arranged to the protected target, which means is connected to an extinguishing-medium source. From the effect of the fire, at least one opening 4 is formed to the wall of the hose means, which wall is formed of at least two layers 2, 3, from which opening extinguishing medium is brought to the fire area and/or its vicinity with a pipe or hose means 1.

To the wall 2, 3 of the pipe or hose means 1 is influenced, advantageously with the heat of the fire, so that at least one opening 4 is formed to the wall of the pipe or hose means from which opening the extinguishing medium may spray. The thermal effect caused by the fire typically makes the part at least in the vicinity of the fire area to burn and/or melt so that an opening is formed from which opening the extinguishing medium is able to spray to the fire area or its vicinity.

According to an embodiment of the method, at least one layer 2 comprises reinforcement material which has several openings 4 in the longitudinal direction and the transverse direction, and at least one other layer 3 comprises extinguishing-medium-durable material which burns and/or softens and melts from the effect of heat, whereupon at least one of the layers 2, 3 of the wall is influenced so that at least one opening 4 is formed through the wall, and that a pressure effect is directed to the extinguishing medium, in consequence of which the extinguishing medium is conveyed from the opening 4 having formed in the wall of the hose means.

According to an embodiment of the method, the extinguishing medium of the pipe or hose means 1 is kept in stand-by pressure, and the flow of the extinguishing medium is monitored between the hose means and the extinguishing-medium source, whereupon when the flow has reached a set value, more extinguishing medium is conveyed to the extinguishing piping system.

In addition, extinguishing medium, advantageously extinguishing-medium mist, may be sprayed with at least one spraying head 15.

In supplying the extinguishing medium, high pressure may be utilised, advantageously 15-300 bar.

In a method according to an embodiment of the invention, a pipe or hose element is utilised as part of a fire-extinguishing system which has an extinguishing-medium source 16 and at least one main pipeline 12 and directly to it or through a branch pipe 13, 14 is connected at least one hose means 1, 1A, 1B, 1C, 1D, 1E, 1F so that, in a fire situation, at least one opening is formed to the hose element from which opening the extinguishing medium is sprayed to the fire area and/or its vicinity, and if required, the extinguishing medium is sprayed with at least one spraying head 15 arranged to the main pipeline 12 and/or the branch pipe 13, 14 and/or pipe or hose element 1, 1A, 1B, 1C, 1D, 1E, 1F.

According to an embodiment of the invention, a different space is protected with the pipe or hose means 1, 1A, 1B, 1C, 1D, 1E, 1F than with the spraying head 15, by directing the pipe or hose means through the space in question. Such spaces may be, for example, ceiling spaces, attic spaces, or other spaces in which it is not viable to use spraying heads.

Typically, the pipe or hose means 1, 1A, 1B, 1C, 1D, 1E, 1F is directed in the vicinity of easily inflammable objects, such as cables, pipes or equivalent, especially with cable racks 11.

In addition, the hose means may also be utilised for protecting other objects either solely by itself or in addition to other extinguishing means. Such other applicable protected objects are, for example, oil or chemical tanks and their structures, for example, cover structures or equivalent moving according to the degree of filling of the tank.

The hose means 22 is utilised integrated to a cable 20, a pipeline or their combination (FIG. 5).

Liquid or gas or a mixture of liquid and gas is utilized as the extinguishing medium. Typically, water may be utilised as the extinguishing medium as such or so that different additives have been added to it depending on each requirement and application. Then, as the extinguishing medium, inter alia, aqueous film-forming foam or extinguishing foam may be thus utilised. In addition, depending on the circumstances, inter alia, additives increasing frost-proofness may be utilised. If required, also gas may be utilised as the extinguishing medium. As gas, extinguishing gas known per se, such as nitrogen or carbon dioxide etc., may be utilised. The gas, such as carbon dioxide, may also exist in the hose means pressurised in liquid form.

In an embodiment, the extinguishing medium is circulated through a hose means, whereupon the hose means 1 functions as a cooling circuit or part of it. This is an extremely advantageous embodiment, for example, in connection with large cables, the problem of which is heating.

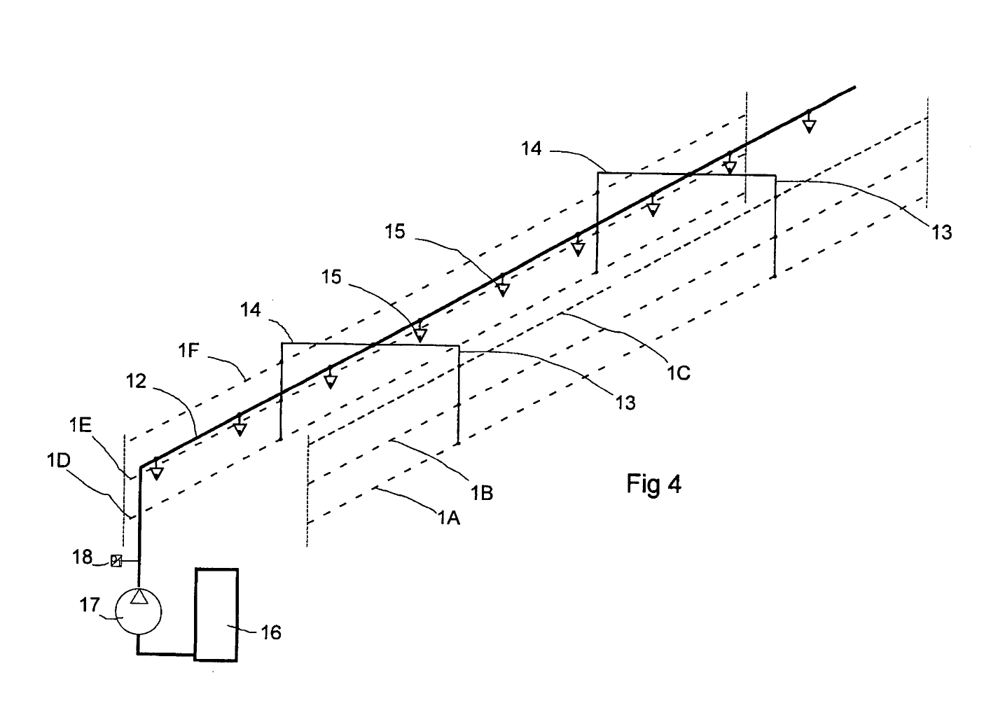

FIGS. 3 and 4 present an embodiment of an apparatus according to the invention, especially in connection with cable tunnels 10. The hose means 1A, 1B, 1C, 1D, 1E, 1F may naturally be utilised for protecting cable tunnels 10 also solely when they are connected to a suitable extinguishing-medium source. FIG. 4 shows schematically the extinguishing-medium source 16. The pump device 17 is connected to the extinguishing-medium source 16 and the hose means 1A . . . 1F either directly or, as described in the figure, through the main line 12 and the branch lines 13, 14. Instead of the pump device or in addition to it, another suitable pressure source may be utilised, such as pressure tanks by means of the pressure of which the extinguishing medium is conveyed to hose elements at least in a fire situation.

The embodiment of the fire-extinguishing apparatus according to the invention comprises thus an extinguishing-medium source and a means for conveying the extinguishing medium to at least one nozzle 15. In addition, the apparatus comprises at least one hose means 1, 1A, 1B, 1C, 1D, 1E, 1F which is connected to the extinguishing-medium source, the wall of which hose means 2, 3 is at least partially formed of a material which burns and/or softens and melts from the effect of intense heat so that at least one opening 4 is formed to that wall of the pipe or hose means for, at least when the pipe or hose means is located in the vicinity of the fire area, spraying the extinguishing medium.

The apparatus of FIGS. 3 and 4 comprises a main line 12 and branch lines 13, 14 connected to it, and the hose means are connected to the branch lines 13, 14. Different hose means are arranged between the branch lines and connected to them with a connecting means known per se, whereupon the extinguishing medium has a connection between the branch lines and the hose means.

The apparatus is arranged to an elongated space, such as a tunnel 10, especially to a cable tunnel, whereupon the hose means 1A, 1B, 1C, 1D, 1E, 1F are arranged in the vicinity of the lines, pipes or other equivalent protected targets passing in the tunnel.

The hose elements 1A, 1B, 1C, 1D, 1E, 1F of the apparatus are arranged to cable racks 11, to a ceiling space, to a lower floor space or to an equivalent relatively narrow and confined space.

The apparatus comprises a means 18 for monitoring the extinguishing-medium flow. Typically in a fire situation, when a hole is formed in the hose element 1, extinguishing medium starts to spray from the hole, whereupon a signal is transmitted from the flow detector 18 on the basis of which signal more extinguishing medium is conveyed to the piping system. This may thus be a consequence of the starting up of the pump means 17 or the opening of a valve element between the pressure source and the piping system (not shown in the figures).

The apparatus comprises also a spraying means, such as a sprinkler means 15. In FIGS. 3 and 4, to the upper part of the space 10, advantageously to the main line 12, are arranged spraying heads 15, especially sprinkler heads which are provided with ampoules or other triggering means which achieve the activation of the spraying head from the effect of the fire. In an event of fire, the system may thus be activated because of the opening formed to the pipe or hose element based on the signal given by the flow detector. The spraying heads 15 may be of such type that they may spray the extinguishing medium, if required, even though the ampoule of the spraying head has not broken as a consequence of the fire.

Another advantageous target of application of the means and apparatuses according to the invention is protecting buildings from, for example, attic fires. FIGS. 6 and 7 present a simplified embodiment of the apparatus. Typically, building roofs have a low space between a ceiling 31 and a roof 32, in which the supporting structures of the roof (not shown in the figure), such as roof trusses, are located. Traditionally, it has been difficult and cost-expensive to protect these spaces with conventional spraying heads. This embodiment is based on an idea according to which the pipe or hose means 1 according to the invention are utilised as part of an extinguishing-medium flow path which protects interior spaces and passes to spraying heads 15. Then, the pipe or hose means according to the invention is arranged to circulate through the space in question. On the other hand, solely a pipe or hose means may be arranged to the protected target, for example, at regular intervals to the floor and/or the ceiling of the space. According to an advantageous arrangement of this embodiment, the extinguishing-medium lines passing to the spraying heads and utilised for the protection of building interior spaces are comprised, according to the invention, of a hose means which has been directed through the space between the ceiling and the roof. Then, the attic space becomes advantageously protected without separate spraying heads. Correspondingly, ceiling spaces or equivalent may be protected.

As the extinguishing medium, an aqueous extinguishing medium, such as water and/or water with additive which intensifies extinguishing, and/or a mixture of an aqueous extinguishing medium and gas, or gas is utilised.

It is obvious to those skilled in the art that the invention is not limited to the embodiments described above, but it may be varied within the scope of the enclosed claims. In the description, several characteristic features presented in combination may also be independent characteristic features.

1. A fire-extinguishing method, in which method at least one pipe or hose means (1), which is connected to an extinguishing-medium source, is arranged to a protected target, characterised in that, from the effect of the fire, at least one opening (4) is formed to the wall of the pipe or hose means, which wall is comprised of at least two layers (2, 3), from which opening the extinguishing medium is brought to the fire area or its vicinity with the pipe or hose means (1).

2. A method according to claim 1, characterised by influencing the wall (2, 3) of the pipe or hose means (1), advantageously with the heat of the fire so that to the wall of the pipe or hose means is formed at least one opening (4) from which the extinguishing medium is able to spray.

3. A method according to claim 1, characterised in that at least one layer (2) comprises reinforcement material which has several openings (4) in the longitudinal direction and the transverse direction, and at least one other layer (3) comprises extinguishing-medium-durable material which burns and/or softens and melts from the effect of heat, whereupon at least one of the layers (2, 3) of the wall is influenced so that at least one opening (4) is formed through the wall, and that a pressure effect is directed to the extinguishing medium, in consequence of which the extinguishing medium is conveyed from the opening (4) having formed in the wall of the pipe or hose means.

4. A method according to claim 1, characterised by keeping the extinguishing medium of the pipe or hose means (1) in stand-by pressure and monitoring the flow of the extinguishing medium between the pipe or hose means and the extinguishing-medium source, whereupon when the flow has reached a set value, more extinguishing medium is conveyed to the extinguishing piping system.

5. A method according to claim 1, characterised by additionally spraying extinguishing medium, advantageously extinguishing-medium mist, with at least one spraying head (15).

6. A method according to claim 1, characterised by utilising high pressure in supplying the extinguishing medium, advantageously 15-300 bar.

7. A method according to claim 1, characterised by utilising in the method a pipe or hose element as part of a fire-extinguishing system which has an extinguishing-medium source (16) and at least one main pipeline (12) and directly to it or through a branch pipe is connected at least one hose means (1, IA, IB, 1C, ID, IE, IF) so that, in a fire situation, at least one opening is formed to the hose element from which opening the extinguishing medium is sprayed to the fire area and/or its vicinity, and if required, the extinguishing medium is sprayed with at least one spraying head (15) arranged to the main pipeline (12) and/or the branch pipe (13, 14) and/or pipe or hose element (1, IA, IB, 1C, ID, IE, IF).

8. A method according to claim, characterised by protecting a different space with the pipe or hose means (1, IA, IB, 1C, ID, IE, IF) than with the spraying head, by directing the pipe or hose means through the space in question.

9. A method according to claim, by directing the pipe or hose means (1, IA, IB, 1C, ID, IE, IF) in the vicinity of easily inflammable objects, such as cables, pipes or equivalent, especially with cable racks (11).

10. A method according to claim, by utilising the hose means (22) integrated to a cable (20), a pipeline or their combination (FIG. 5).

11. A method according to claim, by utilising liquid or gas or a mixture of liquid and gas as the extinguishing medium.

12. A method according to claim, by circulating the extinguishing medium through the pipe or hose means so that the pipe or hose means (1) functions as a cooling circuit or part of it.

13. A fire-extinguishing apparatus, which comprises an extinguishing-medium source (16) and a means for conveying the extinguishing medium to at least one nozzle (15), characterised in that the apparatus comprises at least one hose means (1, IA, IB, 1C, ID, IE, IF), which is connected to the extinguishing-medium source, the wall (2, 3) of which hose means is at least partially formed of a material which burns and/or softens and melts from the effect of intense heat so that at least one opening (4) is formed to that wall of the pipe or hose means for, at least when the pipe or hose means is located in the vicinity of the fire area, spraying the extinguishing medium.

14. A fire-extinguishing apparatus according to claim 13, characterised in that the apparatus comprises a main line (12) and possibly branch lines (13, 14) connected to it, and the hose means are connected to the main line and/or the branch lines (13, 14).

15. A fire-extinguishing apparatus according to claim 13, characterised by the apparatus being arranged to an elongated space, such as a tunnel (10), especially to a cable tunnel, whereupon the hose means (IA, IB, 1C, ID, IE, IF) are arranged in the vicinity of the lines, pipes or other equivalent protected targets passing in the tunnel.

16. A fire-extinguishing apparatus according to claim 13, characterised in that the hose elements (IA, IB, 1C, ID, IE, IF) of the apparatus are arranged to cable racks (11), to a ceiling space, to a lower floor space or to an equivalent relatively narrow and confined space.

17. A fire-extinguishing apparatus according to claim 13, characterised in that the apparatus comprises a means (18) for monitoring the extinguishing-medium flow.

18. A fire-extinguishing apparatus according to claim 13, characterised in that the apparatus comprises a spraying means, such as a sprinkler means (15).

19. A fire-extinguishing apparatus according to claim 13, characterised by utilising an aqueous extinguishing medium, such as water and/or water with additive which intensifies extinguishing, and/or a mixture of an aqueous extinguishing medium and gas, or gas as the extinguishing medium.

20. A fire-extinguishing means, which is formed of an elongated pipe or hose element comprising a wall and a space defined by it (W) for conveying the extinguishing medium, characterised in that the wall is formed of at least two layers (2, 3), at least one of which is of material sensitive to increased temperature which melts, burns or otherwise weakens as a result of increased temperature so the extinguishing medium being pressurised in the space (W) is able to pass through the wall to its outer side.

21. A fire-extinguishing means according to claim 20, characterised in that at least one of the wall layers (2, 3) is of fire-resistant material which comprises openings (4).

22. A fire-extinguishing means according to claim 20, characterised in that at least one of the wall layers (2, 3) is of cloth, advantageously of metal-cloth, such as steel-cloth.

23. A fire-extinguishing means according to claim 20, characterised in that at least one of the layers (2, 3) comprises holes (4), thinnings or equivalent.

24. A fire-extinguishing means according to claim 20, characterised in that the first layer of the wall from the outside (3) is of thermo-sensitive material, and at least one following layer (2) is of reinforcement material which better endures fire.

25. A fire-extinguishing means according to claim 20, characterised in that, when inspecting the wall from the outside to the inside, after the reinforcement layer (2) there is more thermo-sensitive material.

26. A fire-extinguishing means according to claim 20, characterised in that the fire-extinguishing means (22) is integrated in a pipe, hose and/or cable means (20).

27. A fire-extinguishing means according to claim 20, characterised in that the extinguishing medium is liquid, gas, or a mixture of liquid and gas.

28. A fire-extinguishing means according to claim 20, characterised in that it is a hydraulic hose known per se, advantageously enduring of high pressure.

29. A fire-extinguishing means according to claim 20, characterised in that it is part of a flow path of the extinguishing medium directed to at least one nozzle (15).
